(19) United States
(12) Patent Application Publication
(10) Pub. No.: US 2010/0079285 A1
(43) Pub. Date: Apr. 1, 2010

(54) ADJUSTABLE SECURITY DEVICE FOR LAPTOP COMPUTER

(75) Inventors: Chris Fawcett, Charlotte, NC (US); Jon Fawcett, Stow, OH (US)

Correspondence Address: Christopher C. Dremann, P.C., 15015 Lancaster Highway, Charlotte, NC, 28277, US

(73) Assignee: INVUE SECURITY PRODUCTS INC., Charlotte, NC (US)

(21) Appl. No.: 12/571,875

(22) Filed: Oct. 1, 2009

Related U.S. Application Data
(60) Provisional application No. 61/101,759, filed on Oct. 1, 2008.

(51) Int. Cl. G08B 13/14; E05B 65/00

(52) U.S. Cl. 340/568.1; 70/57.1

(57) ABSTRACT

An adjustable security device is configured for engaging and securing items of merchandise having various widths and thicknesses. The security device includes an adjustment mechanism that manipulates in a lateral direction a pair of opposed arms having retaining members for engaging the opposed sides and top of the item. The retaining members are operable to simultaneously engage and secure the item against removal from the security device in the lateral direction as well as a vertical direction, while at the same time permitting a potential purchaser to examine and operate a demonstration model of the item. Each of the retaining members may be pivotally mounted or slidably mounted to one of the opposed arms and at least one of the opposed arms is configured for extending and retracting movement relative to the base in the lateral direction. The security device may further include a lock for locking the opposed arms in a desired lateral position.

### CROSS REFERENCE TO RELATED APPLICATION

This application is a non-provisional of U.S. Provisional Patent Application Ser. No. 61/101,759, filed Oct. 1, 2008, the disclosures of which are incorporated herein.

### BACKGROUND OF THE INVENTION

This invention relates generally to security devices for protecting items of merchandise, such as consumer electronics products (e.g. a laptop computer; DVD player; etc). More particularly, the invention relates to a security device that is adjustable to accommodate items of merchandise having various widths and thicknesses. In one advantageous embodiment, the invention is an adjustable security device for a laptop computer including an adjustment mechanism that manipulates a pair of opposed arms having retaining members for engaging opposed sides of the computer in a manner that prevents removal of the laptop from the security device in the lateral direction as well as the vertical direction.

It is common practice for retailers to provide demonstration models of relatively expensive consumer electronics products, such as laptop computers and digital video disc (DVD) players, so that a potential purchaser may examine the product more closely and test the operation of its features. A working demonstration model, however, increases the possibility that the demonstration model, or a removable component thereof, such as a battery pack, battery, memory card, lens, etc., will be stolen or removed from the display area by an unauthorized person. As a result, demonstration models of consumer electronics products are typically protected by a security device that permits a potential purchaser to examine and operate the product, while reducing the likelihood that the demonstration model or a removable component of the product will be stolen or removed from the display area.

Certain consumer electronics products are more difficult to protect than others. For example, cell phones and digital cameras are relatively small and include removable components that are easily separated from one another. Cell phones and digital cameras commonly include a battery pack (or one or more individual batteries) and a memory card for storing video, audio and/or data files. The product and each removable component must be separately secured against theft without interfering with the potential purchaser's ability to examine and operate the demonstration model. This requirement typically results in the use of a security device having multiple sensors placed at different locations on the product. The use of multiple sensors can make it more difficult for the potential purchaser to operate the demonstration model, and thus adversely influence the decision to purchase. Furthermore, the provision of multiple sensors necessarily increases the complexity of the security device, and as a result, the possibility that the device may malfunction and produce a false indication of theft.

Laptop computers, although larger in size and typically including components that are more difficult to remove, are likewise problematic to protect since access to the various input devices and ports must be provided without hindering the potential purchaser's freedom to examine and operate the demonstration model. For example, all essential keyboard components must be readily accessible and the display screen of the laptop must be clearly visible without significant obstruction. Furthermore, any security device must be able to accommodate the various widths and thicknesses of different models and brands of laptop computers without compromising the security of the demonstration model. A particular concern for securing a laptop computer against theft is that providing adjustment of the device in one dimension (e.g., width) may compromise or diminish security of the computer by the device in another dimension (e.g., height or thickness). In particular, securing the computer against removal from the device in the lateral direction may cause the computer to be more vulnerable to removal from the device in the vertical direction.

Accordingly, there exists an unresolved need for a reliable and effective security device for protecting items of merchandise, while permitting a potential purchaser to examine and operate a demonstration model of the item. There exists a more specific need for a security device that is adjustable to accommodate different brands and models of laptop computers having various widths and thicknesses. There exists a further specific need for an adjustable security device including an adjustment mechanism that manipulates a pair of opposed arms having retaining members for engaging opposed sides of a laptop computer in a manner that prevents removal of the laptop computer from the security device in the lateral direction as well as the vertical direction.

### BRIEF SUMMARY OF THE INVENTION

The aforementioned needs, objectives and advantages, as well as others readily apparent to those of ordinary skill in the art, are provided by an adjustable security device for accommodating items of merchandise having various widths and thicknesses within a predetermined range. In a particular embodiment, the security device includes an adjustment mechanism that manipulates a pair of opposed arms having retaining members for engaging the opposed sides of the item of merchandise. The retaining members operate to simultaneously engage and secure the item of merchandise against removal from the device in the lateral direction as well as the vertical direction, while at the same time permitting a potential purchaser to closely examine and operate a demonstration model of the item of merchandise.

In one aspect, the invention is embodied by an adjustable device for securing an item including a base dimensioned for housing at least an inner portion of a pair of opposed arms. At least one of the arms is configured for extending and retracting movement relative to the base and the device further includes a lock for locking the opposed arms in a desired position relative to the base. The base may be provided with a wall depending from the base in a direction that is generally perpendicular to the direction of the extracting and retracting movement of the at least one of the opposed arms. The device further includes a retaining member mounted at the distal end of each of the opposed arms. The retaining members are operable for engaging and securing the item against movement in at least two generally perpendicular directions.

In another aspect, the invention is embodied by an adjustable security device including a base and a pair of opposed arms with at least one of the opposed arms adapted for extending and retracting movement relative to the base. Each of the opposed arms includes a retaining member mounted at its distal end. The base is dimensioned for housing an inner portion of each arm and a lock for locking the opposed arms in a desired position relative to the base. The base may further include a rear wall depending in a direction generally perpendicular to the direction of the extracting and retracting movement of the opposed arms. The base may further be dimensioned and configured to house an adjustment mechanism for moving at least one of the opposed arms in the direction of the extending and retracting movement, and thereby positioning the opposed arms relative to the base. The base may also be dimensioned and configured to include one or more sensors for detecting whether an item of merchandise previously positioned on the security device is no longer in contact with the base. The one or more sensors may be electrically connected to monitoring circuitry for detecting an unsecured state in which the item of merchandise is no longer in contact with the base, and for activating an alarm indicating the unsecured state.

In yet another embodiment, the invention is embodied by an adjustable device including a base and a first pair of opposed arms extending outwardly from the base in a first direction. The device further includes adjustment means for adjusting the position of at least one of the opposed arms in the first direction relative to the base within a predetermined range of adjustment. The device further includes lock means for locking the position of the pair of opposed arms relative to the base. In a preferred embodiment, the adjustment means includes a rotatable inner gear having gear teeth adapted to engage a plurality of corresponding rack teeth disposed on the opposed arms that extend linearly in the first direction. The lock means includes a co-rotating outer gear having gear teeth adapted to engage at least one stationary locking tooth when the lock means is in a locked position. In another preferrad embodiment, the device further includes a second pair of opposed arms extending outwardly from the base in a second direction that is generally perpendicular to the first direction. In either embodiment, the device further includes a retaining member mounted at the distal end of each opposed arm for engaging and securing an item in the first direction or the second direction, as well as a third direction that is generally perpendicular to both the first direction and the second direction.

### BRIEF DESCRIPTION OF THE DRAWINGS

The present invention is best understood by reference to the following detailed description taken in conjunction with the accompanying drawing figures in which:

FIG. 1 is a front perspective view showing an exemplary embodiment of an adjustable security device according to the present invention operable for simultaneously engaging and securing an item of merchandise, namely a laptop computer, in a lateral direction as well as a vertical direction.

FIG. 2 is a rear perspective view of the adjustable security device of FIG. 1.

FIG. 3 is a front perspective view of the adjustable security device of FIG. 1 shown with the laptop computer removed for purposes of clarity.

FIG. 4 is a top plan view of the adjustable security device of FIG. 3 with a portion of the base removed to show an exemplary embodiment of an adjustment mechanism and lock according to the present invention.

FIG. 5A is a rear elevation view showing the adjustable security device of FIG. 3 configured for use with a laptop computer having a first thickness.

FIG. 5B is a rear elevation view showing the adjustable security device of FIG. 3 configured for use with a laptop computer having a second thickness that is less than the first thickness.

FIG. 5C is a rear elevation view showing the adjustable security device of FIG. 3 configured for use with a laptop computer having a third thickness that is less than the second thickness.

FIG. 6A is a rear elevation view showing another exemplary embodiment of an adjustable security device according to the present invention configured for use with a laptop computer having a first thickness.

FIG. 6B is a rear elevation view showing the adjustable security device of FIG. 6A configured for use with a laptop computer having a second thickness that is less than the first thickness.

FIG. 6C is a rear elevation view showing the adjustable security device of FIG. 6A configured for use with a laptop computer having a third thickness that is less than the second thickness.

FIG. 7 is a top plan view of yet another exemplary embodiment of an adjustable security device according to the present invention operable for simultaneously engaging and securing an item of merchandise with internal components of the device shown in hidden lines.

FIG. 8 is a perspective view of a portion of the underside of the adjustable security device of FIG. 7 showing an exemplary embodiment of a lock for locking the pairs of opposed arms of the device in desired positions.

FIG. 9 is a partial sectional view illustrating the operation of an exemplary embodiment of a lock for use with an adjustable security device according to the present invention.

### DETAILED DESCRIPTION OF EMBODIMENTS OF THE INVENTION

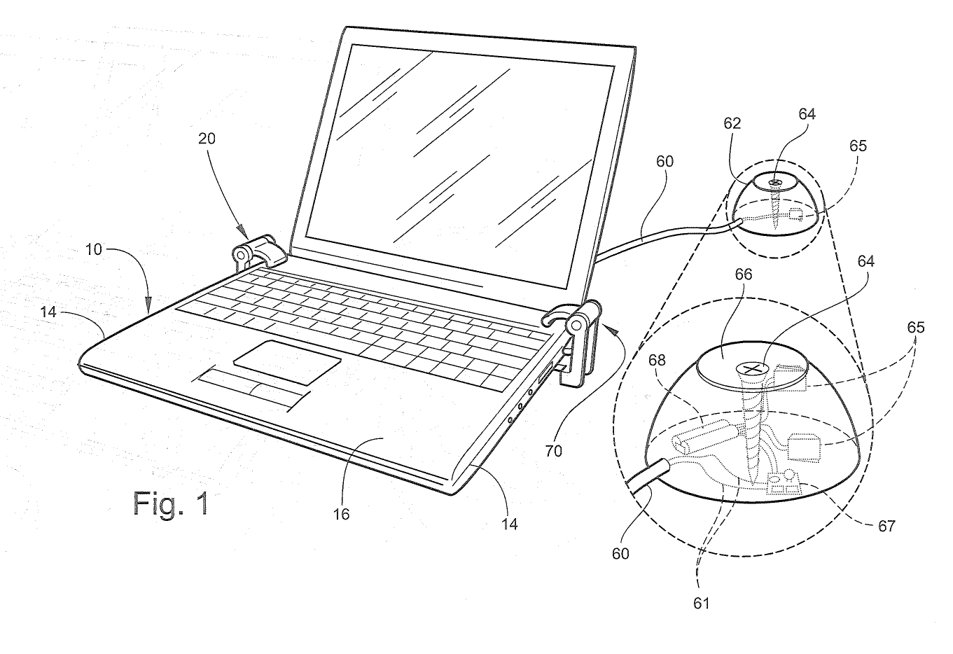

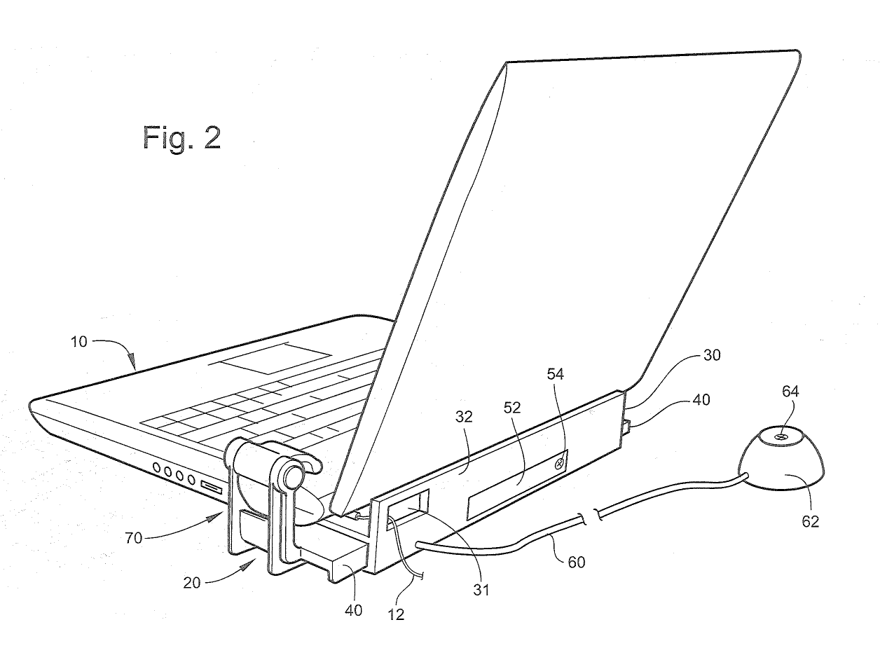

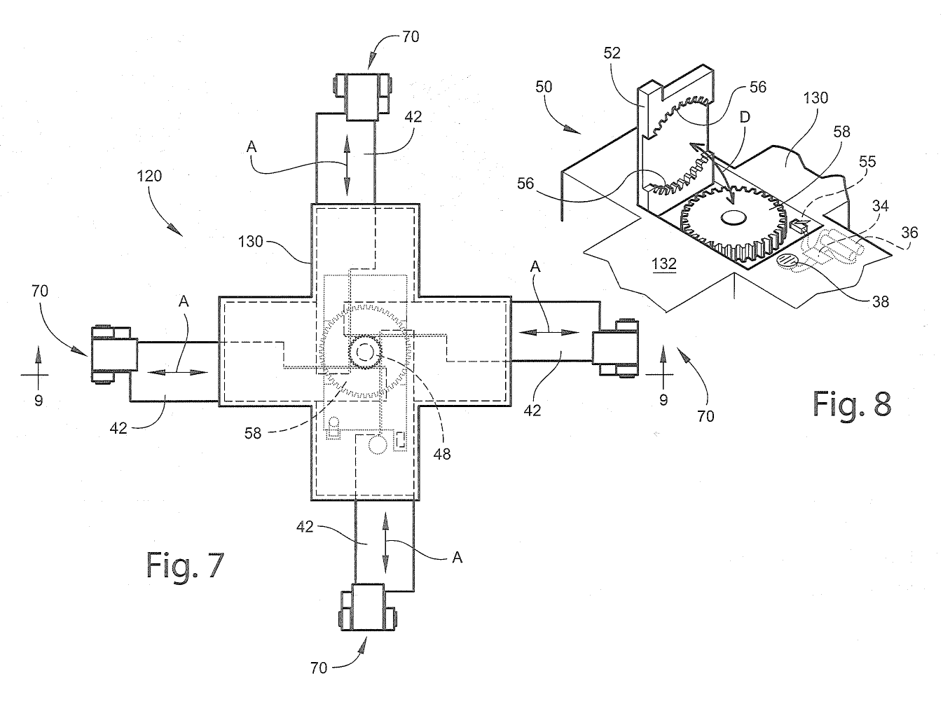

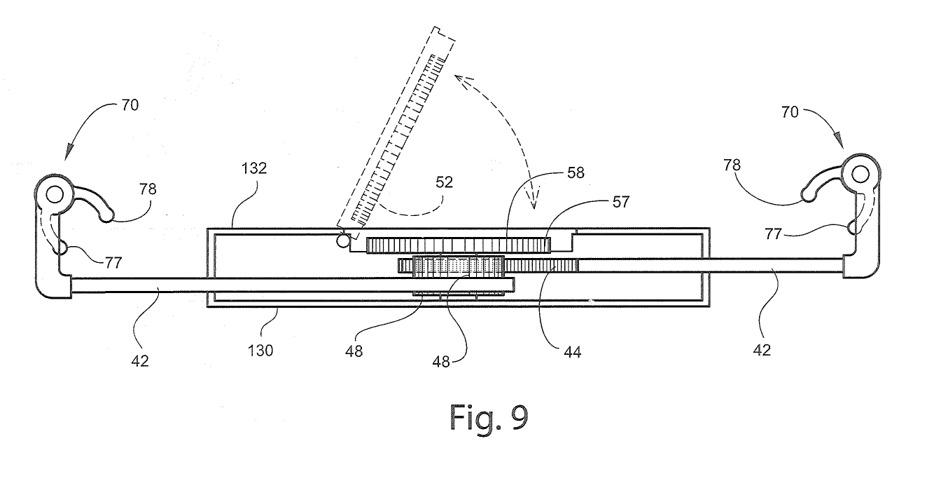

Referring to the accompanying drawing figures wherein identical reference numerals denote the same elements throughout the various views, FIG. 1 and FIG. 2 show an exemplary embodiment of an adjustable security device according to the present invention for protecting an item of merchandise against theft or unauthorized removal. The item of merchandise may be any item, but typically is a relatively large and relatively expensive consumer electronics product (e.g. laptop computer; DVD player; etc.). The item of merchandise shown and described herein for purposes of explanation and not by way of limitation is a laptop computer 10. The adjustable security device, indicated generally at 20, is operable for simultaneously engaging and securing the laptop computer 10 against removal from the device in the lateral direction as well as the vertical direction, while at the same time permitting a potential purchaser to closely examine and operate a demonstration model of the computer in a display area. The security device 20 permits a potential purchaser to examine and test the laptop computer 10, while reducing the likelihood that the demonstration model, or a removable component of the demonstration model, will be stolen or removed from the display area by an unauthorized person. However, the device 20 shown and described herein is suitable for engaging and securing an item of merchandise in a residential or commercial environment, as well as a retail environment, and furthermore, is not intended to be limited to use only as a security display device for protecting against theft and/or unauthorized removal. For example, another exemplary embodiment of an adjustable security device 60 according to the present invention shown in FIG. 7 and FIG. 8 may be utilized to secure an LCD screen, flat-panel television or the like, mounted on an angled or vertical surface, such as a wall.

As shown in FIG. 1 and FIG. 2, the security device 20 comprises a base 30 (FIG. 2) and a pair of opposed arms 40 (FIG. 2) extending outwardly from the base. The opposed arms 40 extend outwardly from the base 30 in a lateral direction and at least one of the opposed arms is configured for extending and retracting movement relative to the base within a predetermined range. The device 20 further comprises a retaining member 70 disposed at a distal end of each of the opposed arms, for a purpose to be described hereafter. The device 20 further comprises a suitable length of a generally flexible security cable 60 for securing the device to a surface of a relatively immovable object, such as a desk, table top, display counter, wall, floor, or the like (not shown). The security cable 60 extends from the base 30 and terminates in a housing 62 having means 64 for attaching the housing to the relatively immovable object. As shown, the fixing means 64 is a conventional wood screw type threaded fastener, but may for example be a nail, a threaded bolt and nut, adhesive, pressure sensitive adhesive such as double-sided tape, hook and loop fasteners (e.g. VELCRO®), or any other suitable means for securely attaching the housing 62 to the object. The security cable 60 permits the laptop computer 10 with the base 30 to be repositioned relative to the housing 62 to an extent limited only by the length and/or flexibility of the security cable.

In an exemplary embodiment, the housing 62 may house at least one position sensor 65 for sensing whether the housing is in contact, or at least in close proximity, with the immovable object. The position sensor 65 may be any known type of sensor suitable for sensing physical contact and/or proximity between the housing 62 and the immovable object, including but not limited to a conventional pressure switch, limit switch, photosensitive (e.g. optical) switch, magnet, or wireless or radio frequency (RF) transmitter. The sensor 65 is electrically connected through security cable 60 to monitoring circuitry that is operably coupled with an alarm disposed within the base 30, as will be described in greater detail hereinafter.

In another embodiment illustrated by the expanded detail view shown in FIG. 1, the housing 62 further comprises a door or cover 66 that is secured to the housing by the fixing means 64 and a second position sensor 65 for sensing whether the cover is in physical contact, or at least in close proximity, with the housing, for example closed. Thus, the position sensors 65 each have a secured state wherein the housing/cover is in contact with the immovable object/housing and an unsecured state wherein the housing/cover is separated from the immovable object/housing. The housing 62 may further house monitoring means, such as an electronic printed circuit board (PCB) 67 having monitoring circuitry for detecting the secured and unsecured states of the position sensor(s) 65, and a power source, such as one or more batteries 68 for supplying power to the position sensor(s) and the PCB. As shown, the security cable 60 contains at least two conductors 61 electrically connected to the PCB 67 for conducting an electrical signal to an audible or visual alarm disposed within the base 30 when a position sensor 65 is in the unsecured state. In addition, the PCB 67 may further comprise an audible alarm, or the housing 62 may comprise a visual alarm (e.g. flashing or continuously illuminated LED), for indicating when a position sensor 65 is in the unsecured state, or if the security cable 60 extending between the housing and the base 30 has been severed.

The base 30 may comprise a rear wall 32 depending from the base in a direction that is generally perpendicular to the lateral direction. With the laptop computer 10 secured on the security device 20 and positioned for display and/or use on a horizontal surface (as is typically the case), the rear wall 32 depends upwardly from the base 30 and the opposed arms 40 in a generally vertical direction perpendicular to the direction of the extracting and retracting movement of the opposed arms. However, the rear wall 32 may depend from the base 30 in any desired manner and at any angle suitable for accommodating the laptop computer 10 in a convenient display and/or use position. As shown in FIG. 2, the rear wall 32 of the base 30 may have at least one opening 31 for permitting an operating cable (e.g. power cord) 12 of the laptop computer 10 to pass through the device 20 and operably connect the laptop computer to a power source and/or a peripheral device or accessory (not shown). The base 30 may further comprise an access door (not shown) configured to be opened or removably mounted on an exterior surface of the base for permitting access to one or more outlet and/or inlet ports of the laptop computer 10, such as a printer port, USB port and/or Ethernet (e.g. RJ45) port. The access door may be secured to the base 30 by a conventional fastener, spring clips, or by other suitable means.

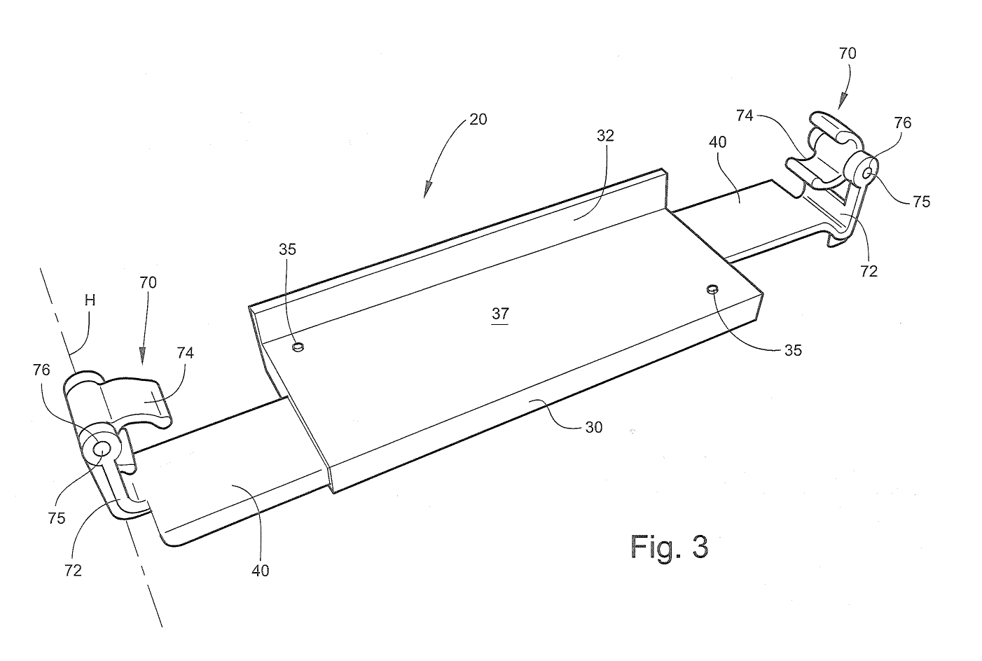

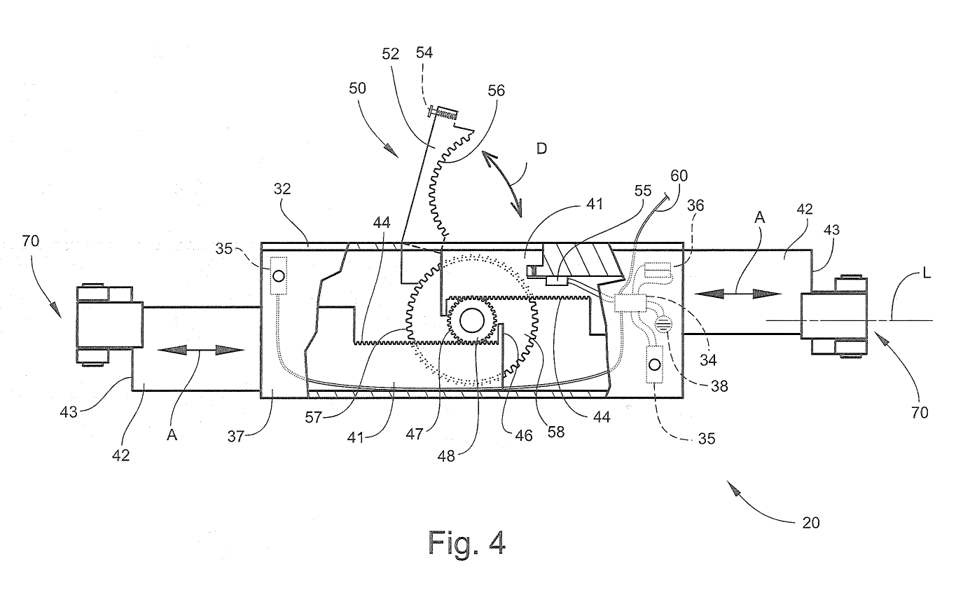

FIG. 3 shows the adjustable security device 20 with the laptop computer 10 removed (i.e. uninstalled) for purposes of clarity. FIG. 4 shows an exemplary embodiment of an adjustment mechanism and locking means for an adjustable security device according to the present invention that includes all of the features of the security device 20 shown in FIGS. 1-3. Accordingly, like reference characters are used for the features previously described and further discussion of those features is provided only to the extent necessary for a complete and enabling understanding of the invention. As shown in greater detail in FIG. 3 and FIG. 4, the opposed arms 40 are arranged opposite and juxtaposed to one another. However, each of the retaining members 70 is offset relative to the corresponding opposed arm 40 towards the lateral centerline axis of the base 30, indicated by reference character L in FIG. 4, such that the retaining members are aligned opposite one another substantially along the lateral centerline axis L. In this manner, the retaining members 70 exert only an inward retaining force on the opposed sides 14 (see FIG. 1) of the laptop computer 10 and do not exert an unbalanced force or twisting moment on the laptop computer.

As shown in FIG. 4, each of the opposed arms 40 comprises an inner portion 41 that is entirely disposed within the base 30 and an outer portion 42 that is extensible and retractable relative to the base in the lateral direction, as illustrated by the double-headed arrow indicated by reference character A. As previously described, the retaining members 70 are disposed at the distal (i.e. outer) ends 43 of the outer portions 42 of the opposed arms 40. The inner portions 41 of the opposed arms 40 are constructed narrower than the outer portions 42 in a horizontal (i.e. depth) direction perpendicular to the lateral direction, and are provided with a plurality of rack teeth 44 extending linearly along the inner portions in the lateral direction. A mechanical stop 46 may be provided at the proximate (i.e. inner) end of each inner portion 41 to prevent over-extension of the opposed arms 40 relative to an annular rotating gear 48. The gear 48 is provided with a plurality of gear teeth 47 that engage and cooperate with the rack teeth 44 to control the extracting and retracting movement of the opposed arms 40 relative to the base 30. In the exemplary embodiment shown in FIG. 4, the gear teeth 47 of the gear 48 and the rack teeth 44 of the inner portions 41 of the opposed arms 40 cooperate in the well known manner of a conventional “rack and pinion.” However, the particular means for adjusting the positions of the opposed arms 40 relative to the base 30 and the particular adjustment mechanism utilized are not essential to the operation and function of the adjustable security device 20. Accordingly, the invention is not intended to be limited by the “rack and pinion” means and adjustment mechanism shown and described herein. Instead, any suitable means for adjusting the lateral positions of the opposed arms 40 relative to the base 30 now known or hereafter devised by one of ordinary skill in the art may be utilized and considered to be encompassed by the inventive concept of the present invention.

As best shown in FIG. 4, the adjustable security device 20 further comprises a lock, indicated generally at 50, operable for locking the opposed arms 40 in desired lateral positions relative to the base 30. Lock 50 comprises a door 52 pivotally mounted on the rear wall 32 of the base 30 for rotation relative to the base in the direction illustrated by the double-headed arrow indicated by reference character D. The door 52 is secured to the rear wall 32 of the base 30 in a closed position by a fastener 54. The fastener 54 may be any suitable means for securely attaching the door 52 to the base 30, such as a threaded screw or a plunger and push-pin type fastener. Furthermore, the door 52 may be removable and secured to the rear wall 32 of the base 30 by one or more fasteners 54, a snap-fit, a slight interference fit, or one or more resilient prongs, projections or latches. Regardless, a sensor 55 may be provided for indicating whether the door 52 is in the closed position. The sensor 55 may be any known type of sensor suitable for sensing physical contact and/or close proximity between the door 52 (or alternatively fastener 54) and the base 30, including but not limited to a conventional contact, pressure, limit, photosensitive (e.g. optical) or RF switch. Regardless, the sensor 55 is in a secured state when the door 52 is in the closed position and in an unsecured state when the door is in an opened position (or alternatively when the fastener 54 is removed).

An inner surface of the door 52 is provided with at least one, and preferably, a plurality of door teeth 56 that engage and cooperate with corresponding lock teeth 57 provided on an annular rotatable lock gear 58. Lock gear 58 is mechanically coupled to gear 48, for example through a central shaft, such that the gear 48 is prevented from rotating when the door 52 is in the closed position and the lock teeth 57 of lock gear 58 are engaged with the door teeth 56 provided on the door 52. In the closed position, door teeth 56 on door 52 engage lock teeth 57 on lock gear 58, and thereby prevent gear 48 from rotating. In turn, gear 48 prevents the rack teeth 44, and hence the opposed arms 40, from traveling in the lateral direction. As a result, the opposed arms 40 are locked in a desired position and restrained from further extracting and retracting movement relative to the base 30 until door 52 is opened and the door teeth 56 disengage from the lock teeth 57 of the lock gear 58. If desired, the fastener 54 may have a tamper-proof design so that the door 52 is less likely to be opened inadvertently, or opened by an unauthorized person.

As previously mentioned, sensor 55 indicates whether the door 52 is opened or closed. Base 30 further comprises a printed circuit board (PCB) 34, one or more position sensors 35, a power source (e.g. one or more batteries) 36 and an alarm 38 that are electrically coupled to one another through the PCB. Position sensors 35 are functionally similar in construction to the position sensors 65 previously described and are operable for determining whether the laptop computer 10 is in contact with, or at least in close proximity to, the supporting surface 37 of base 30. Accordingly, the PCB 34 includes monitoring circuitry for detecting the secured and unsecured states of sensors 35, 55 in the manner previously described with regard to PCB 67, and for activating the alarm 38 to produce an audible and/or visual alarm signal when a position sensor 35, 55 is in the unsecured state. Although not shown, the security device 20 may be provided with a suitable power input port and power cable for electrically connecting the PCB 34, and consequently the sensors 35, 55 and the alarm 38, to an external power source. In this instance, the internal power sources 36, 68 described herein may be used for the purpose of back-up when, for example, there is an interruption in power (e.g. power outage), or the power cable or security cable 60 is severed. In other instances, the device may further include a voltage regulator (not shown) and adapter cable (not shown) for providing power to the laptop from the external power source. It should be noted that in the event the security cable 60 is severed between the housing 62 and the base 30, the alarm 38 will continue to receive power from the internal power source 35, and therefore, produce the audible and/or visual signal.

As previously mentioned, the adjustable security device 20 further comprises retaining members 70 disposed at the distal ends 43 of the outer portions 42 of the opposed arms 40. As best shown in FIG. 3, each retaining member 70 comprises a support 72 and a generally C-shaped clamp 74 pivotally mounted to the support. The clamp 74 may be pivotally (i.e. rotatably) mounted to the support 72 in any suitable manner. As shown, the clamp 74 is provided with a pair of protrusions in the form of pegs or posts 75 and the support 72 has at least one, and preferably, a pair of openings 76 formed in a corresponding pair of upwardly depending, spaced-apart legs that define a U-shaped opening for receiving the corresponding clamp. In this manner, the clamps 74 are free to rotate about a generally horizontal axis indicated by reference character H in FIG. 3. The clamps 74 rotate relative to the opposed arms 40 and the base 30 about horizontal axis H that that is generally perpendicular to the lateral centerline axis L. In another embodiment, the retaining members 70 are slidably mounted on the distal ends 43 of the outer portions 42 of the opposed arms 40 at a predetermined angle. In this alternative embodiment, the clamps 74 may be slidably mounted to the support 72 in any suitable manner, for example by at least one boss 79 affixed to an outer surface of the clamp 74 and configured to slide along a corresponding upwardly and angularly depending leg of the retaining member 70. Regardless of whether the clamps 74 are pivotally mounted or slidably mounted, the retaining members 70 permit the opposed arms 40 of the adjustable security device 20 to accommodate items of merchandise (e.g. laptop computers) 10 having different thicknesses, as will be described. As a result of the movement of the opposed arms 40 and the retaining members 70, the security device 20 is adjustable simultaneously in a lateral direction as well as a vertical direction.

An important feature of the adjustable security device 20 of the present invention is that the retaining members 70 are operable to simultaneously engage and secure the item of merchandise (e.g. laptop computer 10) against removal from the device in the lateral direction as well as the vertical direction, while at the same time permitting a potential purchaser to closely examine and operate a demonstration model of the item of merchandise. However, it is commonplace for different manufacturers of items of merchandise, and even different brands of the same merchandise offered by the same manufacturer, to have different thicknesses. Therefore, a further advantage of the present invention is that the retaining members 70 are also capable of engaging and securing items of merchandise having different thicknesses.

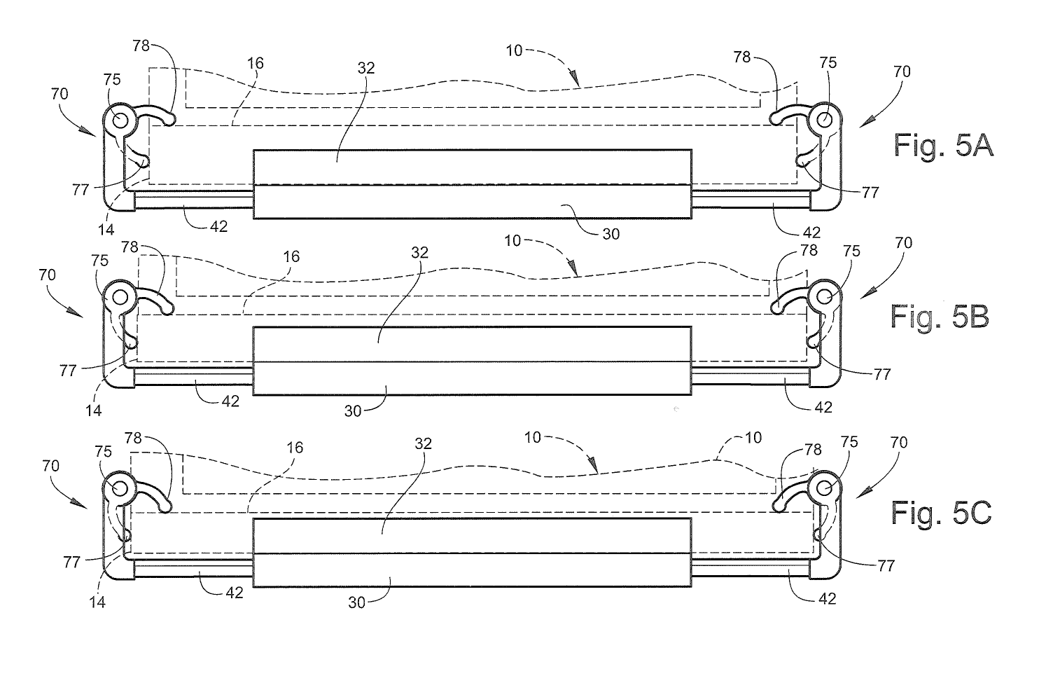

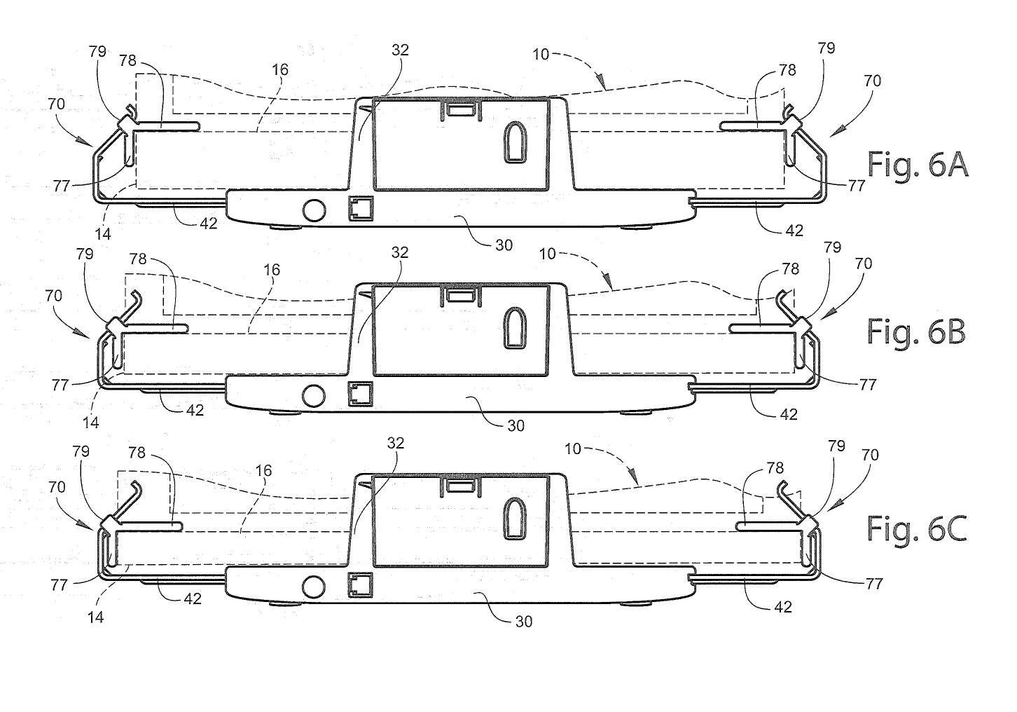

FIGS. 5A-5C and FIGS. 6A-6C illustrate the adjustable security device 20 configured for use with laptop computers 10 having various thicknesses. FIGS. 5A-5C show an adjustable security device 20 provided with retaining members 70 that are pivotally mounted at the distal ends 43 of the opposed arms 40, while FIGS. 6A-6C show an adjustable security device provided with retaining members that are slidably mounted at the distal ends of the opposed arms. In the exemplary alternative embodiments shown and described herein, each clamp 74 comprises a lower finger 77 and an upper finger 78 for engaging one of the opposed sides 14 and the top 16, respectively, of the laptop computer 10. The opposed side 14 and the top 16 of the laptop computer 10 are generally perpendicular in the examples illustrated in FIGS. 5A-5C and FIGS. 6A-6C. However, the pivoting or sliding movement of the clamp 74 permits the fingers 77, 78 of the retaining members 70 to engage and secure an item of merchandise having adjacent surfaces that are generally perpendicular. However, one of ordinary skill in the art will readily understand and appreciate that the fingers 77, 78 of clamp 74 could easily be configured to engage and secure adjacent sides of an item of merchandise having an included angle between about forty-five (45) degrees and about one hundred thirty-five (135) degrees.

Regardless, in the illustrated examples the lower finger 77 engages the side 14 of the laptop computer 10 and the upper finger 78 engages the top 16 of the laptop computer in clamping relation as the opposed arms 40 are retracted inwardly into the base 30 of the security device 20. As a result, the laptop computer is restrained from removal from the security device 20 in the lateral direction A (FIG. 4) by retracting the opposed arms 40 until the lower fingers 77 of the retaining members 70 engage the opposed sides 14 of the laptop computer 10. The clamps 74 then rotate about the horizontal axis H (FIG. 3), or alternatively slide along the upwardly depending leg of the clamp, so that the upper fingers 78 engage the top 16 of the laptop computer. Further retraction of the opposed arms 40 is prevented since lateral force applied to the lower fingers 77 produces a corresponding resisting force from the upper fingers 78 engaging the top 16 of the laptop 10. The laptop computer 10 is simultaneously restrained from being removed from the security device 20 in the vertical direction since an upward force applied to the upper fingers 78 produces a corresponding resisting force from the lower fingers 77 engaging the opposed sides 14 of the laptop computer. As previously shown and described, lock 50 or any other suitable means may be provided to lock the opposed arms 40 in the desired position and thereby prevent extracting movement of the opposed arms relative to the base 30 with the retaining members 70 engaging and securing the laptop computer 10.

FIGS. 7-9 show another exemplary embodiment of an adjustable security device 120 according to the present invention that includes all of the features of the security device 20 previously described and shown in FIGS. 1-4, as well as additional features that will be described hereafter. Accordingly, like reference characters are used for the same or similar features previously described and further discussion of those features is provided only to the extent necessary for a complete and enabling understanding of the present invention. As best shown in FIG. 7, the security device 120 is configured for engaging and securing an item of merchandise (not shown) at four locations as opposed to the device 20 that engages and secures an item of merchandise (e.g. laptop computer 10) at only two locations. More specifically, the security device 120 comprises mutually perpendicular sets of opposed arms 40 of the type previously described with respect to security device 20. The mutually perpendicular opposed arms 40 may be disposed in a stacked relationship or in a juxtaposed relationship. Regardless, the security device 120 may be used to mount an item of merchandise (e.g. an LCD screen, flat-panel television or the like) on a vertical surface, such as a wall. However, the device 120 is not intended to be limited to any particular use or uses, and instead may be utilized to engage and secure any multi-sided item having dimensions within a predetermined range for any purpose. Common examples include, but are not limited to, objects having at least two pairs of laterally opposed sides that are perpendicular to one another, such as square and rectangular shaped objects.

The features of the adjustable security device 120 are essentially the same as previously described with respect to security device 20 with the exception that the base 130 of the device 120 is configured to house two pairs of opposed arms 40 and retaining members 70 arranged generally perpendicular to one another with the opposed arms 40 adapted for extracting and retracting movement relative to the base 130 in the manner previously described. As shown in FIG. 8 and FIG. 9, the lock 50 may be positioned adjacent the underside 132 of the base 130 opposite the topside of the base supporting retaining members 70. As such, the lock gear 58 is mechanically coupled to the rotating gear 48 associated with each of the pairs of opposed arms 40. However, in a preferred embodiment the rotating gears 48 of the two pairs of opposed arms 40 are not mechanically coupled to one another so that the device 130 can accommodate an object having different lateral dimensions, or objects have different aspect ratios (i.e. different ratios of dimensions in the mutually perpendicular directions). In particular, the two pairs of opposed arms 40 may be configured to be independently extensible and retractable so that the device 130 can engage and secure both a rectangular object and a square object. As previously described, the door 52 of the lock may cooperate with a sensor 55 powered by a power source 36 that determines whether the door is in the closed position and provides an electrical signal to a PCB 34 having monitoring circuitry for detecting a state of the sensor and for activating an alarm 38 to provide an audible or visual alarm signal when the sensor 55 is in an unsecured state.

The foregoing has described one or more exemplary embodiments of an adjustable security device for engaging and securing an item of merchandise. The security device is adjustable to accommodate items or objects having various lateral width and thickness dimensions. In particularly advantageous embodiments, the invention is an adjustable security device for a laptop computer including an adjustment mechanism that manipulates a pair of opposed arms having retaining members at distal ends thereof for engaging and securing the opposed sides and the top of the computer in a manner that simultaneously prevents removal of the computer from the security device in the lateral direction and the vertical direction. Although exemplary embodiments of the present invention have been shown and described, it will be apparent to those skilled in the art that various modifications thereto can be made without departing from the spirit and scope of the invention. Accordingly, the foregoing description of preferred embodiments of the invention and the best mode for practicing the invention are provided for the purpose of illustration only, and not for the purpose of limitation. In particular, it will be appreciated that an adjustable security device constructed in accordance with the present invention may be applicable for use with items of merchandise and objects other than consumer electronic products without departing from the spirit and scope of any appended claim.

That which is claimed is:

1. An adjustable security device for engaging and securing an item of merchandise, comprising:
a pair of opposed arms each having a retaining member configured for engaging the item of merchandise, the retaining members operable to simultaneously secure the item of merchandise against removal from the device in a lateral direction as well as a vertical direction, while at the same time permitting a potential purchaser to examine the item of merchandise.

2. The adjustable security device of claim 1, wherein the item of merchandise has opposed sides and wherein the opposed arms are extensible and retractable to engage the opposed sides of the item of merchandise.

3. The adjustable security device of claim 2, wherein the item of merchandise further has a top and wherein the retaining members are movable relative to the opposed arms such that each retaining member engages one of the opposed sides and the top of the item of merchandise.

4. The adjustable security device of claim 3, wherein the retaining members are pivotally mounted on the opposed arms and each retaining member comprises a lower finger for engaging the one of the opposed sides of the item of merchandise and an upper finger for engaging the top of the item of merchandise.

5. The adjustable security device of claim 3, wherein the retaining members are slidably mounted on the opposed arms and each retaining member comprises a lower finger for engaging the one of the opposed sides of the item of merchandise and an upper finger for engaging the top of the item of merchandise.

6. The adjustable security device of claim 1, wherein the opposed arms are movable in the lateral direction and further comprising a lock for locking the opposed arms in a desired lateral position.

7. An adjustable device for engaging and securing an item, comprising:
a base dimensioned for housing at least an inner portion of a pair of opposed arms, at least one of the opposed arms being configured for extending and retracting movement relative to the base in a lateral direction; and
a lock for locking the opposed arms in a desired lateral position relative to the base.

8. An adjustable device according to claim 7, wherein the base comprises a wall depending from the base in a vertical direction generally perpendicular to the lateral direction.

9. An adjustable device according to claim 7, further comprising a retaining member disposed at a distal end of each of the opposed arms, the retaining member being operable for simultaneously engaging and securing the item in the lateral direction and a vertical direction generally perpendicular to the lateral direction.

10. An adjustable device according to claim 9, wherein the retaining member is movable relative to the opposed arms in one of a pivotally mounted relationship and a slidably mounted relationship.

11. An adjustable device for engaging and securing an item, comprising:
a base;
a pair of opposed arms operably coupled with the base wherein at least one of the opposed arms is adapted for extending and retracting movement relative to the base in a first direction; and
a retaining member disposed at a distal end of each of the opposed arms, the retaining members movably mounted on the opposed arms and configured for simultaneously engaging and securing the item in the first direction and a second direction different than the first direction.

12. An adjustable device according to claim 11, wherein the base is dimensioned and configured to house an adjustment mechanism for moving the at least one of the opposed arms in the first direction to position the opposed arms at a desired position relative to the base.

13. An adjustable device according to claim 11, wherein the base is dimensioned and configured to house one or more sensors for indicating whether an item previously positioned on the base is no longer in contact with the base.

14. An adjustable device according to claim 13, further comprising monitoring means including monitoring circuitry for detecting an unsecured state of at least one of the one or more sensors when the item is no longer in contact with the base and an alarm for indicating the unsecured state.

15. An adjustable security device for engaging and securing an item, comprising:
a base;
a first pair of opposed arms extending outwardly from the base and movable relative to the base in a first direction;
a first pair of retaining members movably mounted on the first pair of opposed arms;
an adjustment mechanism for adjusting the position of at least one of the first pair of opposed arms in the first direction relative to the base within a predetermined range of adjustment; and
lock means for locking the first pair of opposed arms in a desired position relative to the base against movement in the first direction.

16. An adjustable security device according to claim 15,
wherein the adjustment mechanism comprises a rotatable inner gear having first gear teeth adapted to engage a plurality of corresponding rack teeth disposed on the opposed arms that extend linearly in the first direction; and
wherein the lock means comprises a rotatable outer gear having second gear teeth adapted to engage at least one stationary lock tooth when the outer gear is in a locked position.

17. An adjustable security device according to claim 15, further comprising a second pair of opposed arms extending outwardly from the base in a second direction that is generally perpendicular to the first direction and a second pair of retaining members movably mounted on the second pair of opposed arms, the first retaining members and the second retaining members configured for simultaneously securing the item in the first direction and the second direction, as well as a third direction that is generally perpendicular to the first direction and the second direction.

18. An adjustable security device according to claim 17, wherein each of the first retaining members and the second retaining members comprise a lower finger for engaging and securing the item in one of the first direction or the second direction and an upper finger for engaging and securing the item in the third direction.

19. An adjustable security device according to claim 15, further comprising at least one sensor for indicating whether the item is in contact with the base, monitoring circuitry for detecting an unsecured state of the at least one sensor when the item is no longer in contact with the base, and an alarm for activating an audible or visual alarm signal when the sensor is in the unsecured state.

20. An adjustable security device according to claim 15, wherein each of the first pair of retaining members is one of pivotally mounted and slidably mounted on a corresponding one of the first pair of opposed arms.
